(19) United States
(12) Patent Application Publication
(10) Pub. No.: US 2025/0284475 A1
(43) Pub. Date: Sep. 11, 2025

(54) Java-Based Application Inventory Discovery

(71) Applicant: MICRO FOCUS LLC, Wilmington, DE (US)

(72) Inventors: Vitaly Miryanov, Berkshire (GB); Zhong-Yi Yang, Shanghai (CN); Sheng-Yu Chen, Shanghai (CN); Qiuxia Song, Shanghai (CN)

(73) Assignee: MICRO FOCUS LLC, Wilmington, DE (US)

(21) Appl. No.: 18/596,371

(22) Filed: Mar. 5, 2024

(51) Int. Cl. G06F 8/61; G06F 8/30

(52) U.S. Cl. CPC G06F 8/61; G06F 8/315

(57) ABSTRACT

A system includes at least one processor and a computer readable memory. When executed by the at least one processor, the at least one processor is caused to scan one or more resources associated with a configuration management database (CMDB) and access metadata regarding an installed software application from the scanned one or more resources. The at least one processor is further caused to create a list of candidate resources from the scanned one or more resources based on a number of attributes used to identify the installed software application from the accessed metadata, select a candidate resource based on the number of attributes used to identify the installed software application, identify the installed software application based on the selected candidate resource and update a Software Application Index (SAI) library with the metadata from the candidate resource.

### FIELD

The present disclosure relates generally to systems and methods for identifying installed software applications and more particularly to systems and methods for identifying installed software applications running on a computer system using metadata from resources on the computer system.

### BACKGROUND

Organizations, regardless of size, rely upon access to information technology (IT) and data and services for their continued operation and success. A respective organization's IT infrastructure may have associated hardware resources (e.g. computing devices, load balancers, firewalls, switches, etc.) and software resources (e.g. productivity software, database applications, custom applications, and so forth). Over time, more and more organizations have turned to cloud computing approaches to supplement or enhance their IT infrastructure solutions. To facilitate the management of the organizations' IT infrastructure, configuration management services provide administrators a process by which a configuration management database (CMDB) can be populated by configuration item (CD) s that represent components of the IT infrastructure.

The CMDB tracks information regarding CIs associated with a client. For example, these CIs may include hardware, software, and combinations thereof, disposed on, or operating within, a client network. In order to provide effective resource management, the CI data stored within the CMDB should accurately reflect the current state of the CIs associated with a client network. One way in which the CI data is populated within the CMDB is via a discovery process in which a discovery server operates on the client network to discover CI data, which is then transmitted back to the cloud computing service for storage in the CMDB. All types of software applications, however, cannot be easily recognized by this discovery process.

### SUMMARY

Embodiments of the present disclosure provide systems, methods and non-transitory computer-readable mediums for identifying installed software application running on a computer system using metadata from resources on the computer system. According to one embodiment of the present disclosure, a system includes at least one processor and a computer readable medium, coupled with the at least one processor and comprising processor readable and executable instructions that, when executed by the at least one processor, cause the at least one processor to: scan one or more resources associated with a configuration management database (CMDB), access metadata regarding an installed software application from the scanned one or more resources and create a list of candidate resources from the scanned one or more resources based on a number of attributes used to identify the installed software application from the accessed metadata. The at least one processor is further caused to select a candidate resource based on the number of attributes used to identify the installed software application, identify the installed software application based on the selected candidate resource and update a Software Application Index (SAI) library with the metadata from the candidate resource.

Aspects of the above system include wherein the installed software application is a software application developed using Java programming language and runs on a Java Virtual Machine (JVM).

Aspects of the above system include wherein one of the one or more resources includes a manifest file for the installed software application.

Aspects of the above system include wherein the manifest file includes at least one of a real number, a company name, a file version, a product name, a product version, and a file description for the installed software application.

Aspects of the above system include wherein one of the one or more resources includes a Project Object Model (POM) file associated with the installed software application.

Aspects of the above system include wherein the POM file includes at least one of a real name, a product name, a product version, and a file description associated with the installed software application.

Aspects of the above system include wherein metadata associated with a product version attribute is used to update the SAI library.

Aspects of the above system include wherein the at least one processor is further caused to implement a file version data rule associated with the product version attribute for detecting other installed software applications.

Aspects of the above system include wherein a size of the SAI library is reduced based on the implemented file version data rule.

Aspects of the above system include wherein the at least one processor is further caused to generate, for display, a graphical relationship between the installed software application and a node on which the installed software application is provided.

According to one embodiment of the present disclosure, a method includes scanning, by universal discovery scanner, one or more resources associated with a configuration management database (CMDB), accessing, the universal discovery scanner, metadata regarding an installed software application from the scanned one or more resources and creating, by one or more processors, a list of candidate resources from the scanned one or more resources based on a number of attributes used to identify the installed software application from the accessed metadata. The method further includes selecting, by the one or more processors, a candidate resource based on the number of attributes used to identify the installed software application, identifying, by the one or more processors, the installed software application based on the selected candidate resource and updating, by the one or more processors, a Software Application Index (SAI) library with the metadata from the candidate resource.

Aspects of the above method include wherein the installed software application is a software application developed using Java programming language and runs on a Java Virtual Machine (JVM).

Aspects of the above method include wherein one of the one or more resources includes a manifest file for the installed software application.

Aspects of the above method include wherein the manifest file includes at least one of a real number, a company name, a file version, a product name, a product version, and a file description for the installed software application.

Aspects of the above method include wherein one of the one or more resources includes a Project Object Model (POM) file associated with the installed software application.

Aspects of the above method include wherein the POM file includes at least one of a real name, a product name, a product version, and a file description associated with the installed software application.

Aspects of the above method include, wherein metadata associated with a product version attribute is used to update the SAI library.

Aspects of the above method further includes implementing, by the one or more processors, a file version data rule associated with the product version attribute for detecting other installed software applications.

Aspects of the above method include wherein a size of the SAI library is reduced based on the implemented file version data rule.

According to one embodiment of the present disclosure, a non-transitory computer-readable medium has stored thereon instructions that causes one or more processors to execute a method, the method includes scanning one or more resources associated with a configuration management database (CMDB), accessing metadata regarding an installed software application from the scanned one or more resources and creating a list of candidate resources from the scanned one or more resources based on a number of attributes used to identify the installed software application from the accessed metadata. The method further incudes selecting a candidate resource based on the number of attributes used to identify the installed software application, identifying the installed software application based on the selected candidate resource and updating a Software Application Index (SAI) library with the metadata from the candidate resource.

The details of one or more embodiments of the subject matter described in this specification are set forth in the accompanying drawings and the description below. Other potential features, aspects, and advantages of the subject matter will become apparent from the description, the drawings, and the claims.

The phrases “at least one”, “one or more”, “or”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. For example, the computer readable medium(s) may be non-transitory or non-volatile medium, such as a magnetic disk or solid-state non-volatile memory or volatile medium such as RAM.

As used herein, the term “configuration item” or “CI” refers to a record for any component (e.g., computer, router, device, piece of software, database table, script, webpage, piece of metadata, database instance, server instance, service, and so forth) in an enterprise network, for which relevant data, such as manufacturer, vendor, location, or similar data, is stored in a database (e.g., a “configuration management database” or CMDB).

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine”, “calculate” and “compute,” and variations thereof, as used herein, are used interchangeably and include any type of methodology, process, mathematical operation or technique.

The term “means” as used herein shall be given its broadest possible interpretation in accordance with 35 U.S.C., Section 112 (f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

FIG. 1 is a block diagram illustrating elements of an example computing environment in which embodiments of the present disclosure may be implemented.

FIG. 2 is a block diagram illustrating elements of an example computing system in which embodiments of the present disclosure may be implemented.

FIG. 3 is a block diagram illustrating elements of an example computing environment for identifying installed software applications running on managed devices using metadata from resources on the managed devices in which embodiments of the present disclosure may be implemented.

FIG. 4 is a block diagram illustrating an example software recognition system in which embodiments of the present disclosure may be implemented.

FIG. 5 is a flowchart illustrating an example method for identifying installed software applications running on a computer system using metadata from resources on the computer system according to an embodiment of the present disclosure.

FIG. 6 is a block diagram of a storage medium storing machine-readable instructions according to embodiments of the present disclosure.

FIG. 7 is a block diagram of a system according to embodiments of the present disclosure.

FIG. 8 is an example screen illustration of an exemplary user interface for identifying installed software application using file-based recognition according to an embodiment of the present disclosure.

FIG. 9A is an example screen illustration of an exemplary user interface for identifying installed software applications using package rule rule-based recognition according to an embodiment of the present disclosure.

FIG. 9B is an example screen illustration of an exemplary user interface for identifying installed software applications using package rule rule-based recognition according to an embodiment of the present disclosure.

FIG. 10A is an example screen illustration of an exemplary user interface for identifying installed software applications using file version data rule rule-based recognition according to an embodiment of the present disclosure.

FIG. 10B is an example screen illustration of an exemplary user interface for identifying installed software applications using file version data rule-based recognition according to an embodiment of the present disclosure.

FIG. 11 is an example screen illustration of an exemplary user interface for identifying installed software applications using file version data rule rule-based recognition for a Java-based software application according to an embodiment of the present disclosure.

FIG. 12 is an example list of attributes provided in resources describing an installed software application according to an embodiment of the present disclosure.

FIG. 13 is an example scan file that contains collect JAR file information according to an embodiment of the present disclosure.

FIG. 14 is an example POM file according to an embodiment of the present disclosure.

FIG. 15 is an example POM file according to an embodiment of the present disclosure.

FIG. 16 is an example scan file that contains collect JAR file information according to an embodiment of the present disclosure.

FIG. 17 is an example scan file according to an embodiment of the present disclosure.

FIG. 18 is an example screen illustration of an exemplary user interface for a rule added to software application index (SAI) libraries according to an embodiment of the present disclosure.

FIG. 19 is an example scan file which collects JAR information according to an embodiment of the present disclosure.

FIG. 20 is an example screen illustration of an exemplary user interface for an application CI for a node to be reported to a CMDB according to an embodiment of the present disclosure.

FIG. 21 is an example screen illustration of an exemplary user interface for an application CI for a node to be reported to a CMDB according to an embodiment of the present disclosure.

FIG. 22 is an example screen illustration of an exemplary user interface for a topology of a installed software application and the node on which the software application is installed along with related CIs according to embodiments of the present disclosure.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

Embodiments of the present disclosure are directed to systems and methods for identifying installed software applications running on a computer system using metadata from resources on the computer system. A configuration management database (CMDB) is a software solution that serves as a central repository for managing and storing configuration and relationship data of information technology (IT) assets and infrastructure. A CMDB is designed to provide a comprehensive view of an organization's IT environment, including servers, network devices, applications, databases, virtual machines, and other related components. The CMDB collects and consolidates data from various sources, including by not limited to discovery tools, monitoring systems, manual input, etc. to create a unified and accurate representation of an IT infrastructure. The primary goal of CMDB is to enable organizations to have better visibility and control over their IT assets and a better understanding of the relationships between their IT assets. The CMDB aids in the understanding of the dependencies and impact analysis of configuration items, diagnosing issues, planning changes, and supporting IT service management processes. The CMDB offers features such as automated discovery and mapping of IT assets, configuration item (CI) lifecycle management, relationship modelling, impact analysis, change management and integration with other IT service management tools. The CMDB provides a graphical user interface (GUI) and a set of APIs for accessing and manipulating the configuration data.

A universal discovery (UD) scanner is provided and is one of the most important and powerful components of the CMDB. The UD scanner is used to perform inventory discovery by leveraging the UD scanner's capabilities to collect all information (e.g., central processing unit (CPU), memory, operation system (OS), etc. as well as directories and files information). A scan file is generated from the UD scanner's inventory discovery of all of the system resources. To help parse scan files and report software applications to the CMDB as CIs, software application index (SAI) libraries are used to recognize software applications. Java-based applications are software applications that are developed using the Java programming language and run on the Java Virtual Machine (JVM). Currently, Java-based applications cannot be recognized quickly and efficiently. Therefore, there is a need to solve Java-based application recognition problems.

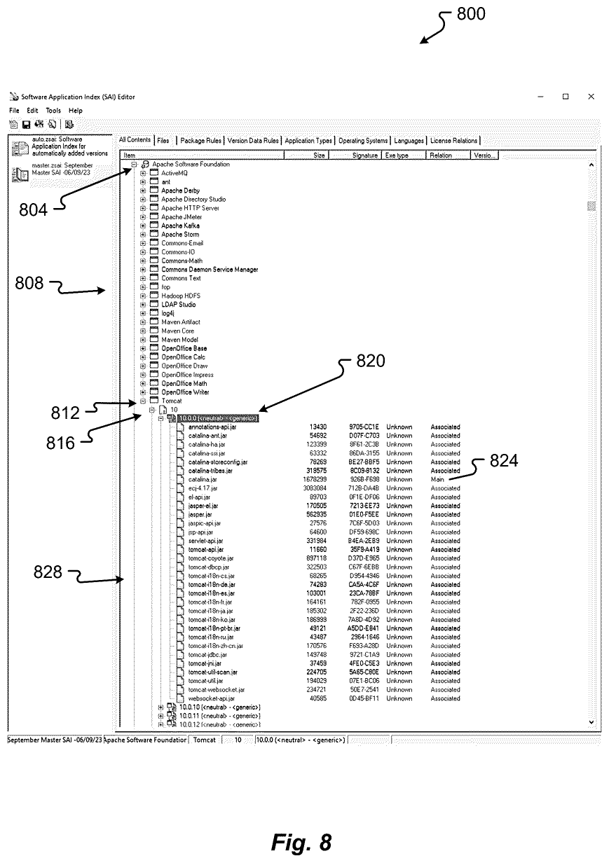

Currently, software applications are recognized using two basic ways: file-based recognition and rule-based recognition. For file-based recognition, it is necessary for all files required by the software application to be listed and then added to the SAI libraries. FIG. 8 is a screen illustration of an exemplary user interface 800 for identifying installed software application using file-based recognition according to an embodiment of the present disclosure. In the example illustrated in FIG. 8, publisher Apache Software Foundation 804 includes many software applications 808. One of the software applications is Tomcat 812. Tomcat 812 includes many files 828 to identify the software application. Tomcat 812 has a release 10 816 and a version 10.0.0 820. One of the files for Tomcat 812 includes catalina.jar 824. Catalina.jar 814 is a main file and is used to recognize the software application Tomcat 812. When comparing this information in the SAI libraries with stored information regarding the software application, all of the file information (e.g., the file name the file size, the signature, etc.) associated with the software application must match. For example, if the file size does not match, the software application Tomcat, release 10, version 10.0.0 would not be recognized.

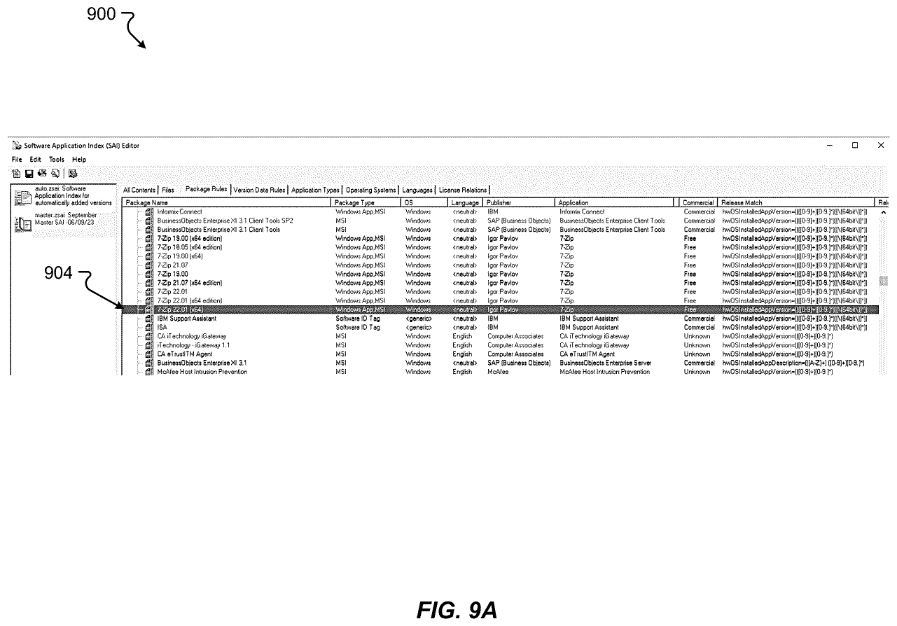

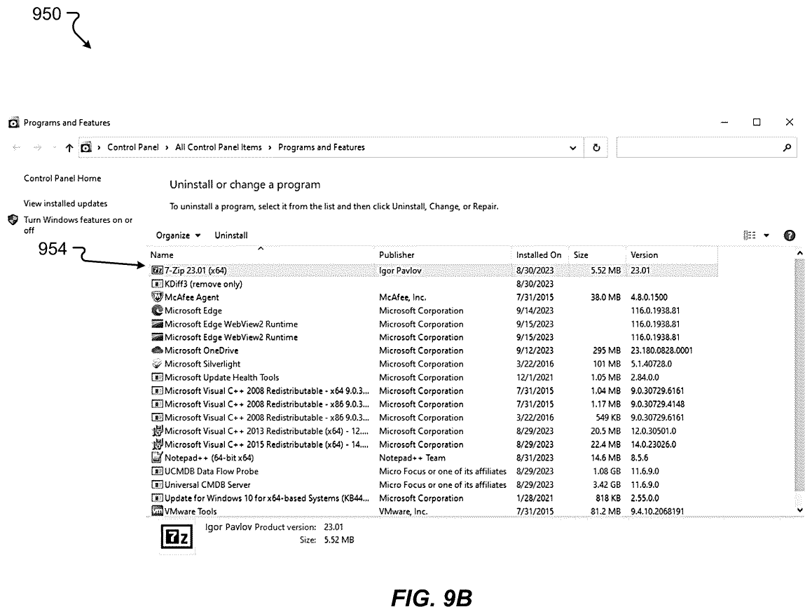

Alternatively, software applications may be distributed in a package (e.g., a series of executable and non-executable files contained within a database or other software container). The package may be installed by an OS utility called a package manager. For package rule rule-based recognition, software applications are recognized directly from registry information. For example, some software applications are registered once fully installed on a device. Based on a fixed or standard format for the registered information, rules are added to the SAI libraries. It is much easier to determine application information using the rule-based recognition compared with the file-based recognition because there is no need to examine all of the files associated with the software application using the rule-based recognition. FIG. 9A is a screen illustration of an exemplary user interface 900 for identifying installed software applications using package rule rule-based recognition according to an embodiment of the present disclosure. As illustrated in FIG. 9A, the highlighted package entry 904 provides the package name “7-Zip 22.01 (x64)”, the package type “Windows APP,MST”, the OS “Windows”, the language “<neutral>”, the publisher “Igor Pavlov”, the software application name “7-Zip”, the software application cost description “free” and the release match “hwOSInstalledAppVersion=((([0-9]+)[0-9.]*)([\64 bit)]*))”. Clicking on the highlighted package entry 904 generates the information provided in FIG. 9B. FIG. 9B is a screen illustration of an exemplary user interface 950 for identifying installed software applications using package rule rule-based recognition according to an embodiment of the present disclosure. As illustrated in FIG. 9B, the highlighted package entry 954 includes the package name “7-Zip 23.01 (x64)”, the publisher “Igor Pavlov”, the installed-on date “Aug. 30, 2023”, the size of the package “5.52 MB” and the version of the package “23.01”. While it may be traditionally relatively easy to discover certain software application information, it has been difficult to identify software applications reliably when the registry information is not in a standard format. For example, the information displayed by the Windows operating system in the “Control Panel>Add or Remove programs> is not standardized and some details such as publisher and version may be missing for many entries. In some cases, the software application may have been removed, but the entry remains, and in some cases, software applications choose not to register in that list.

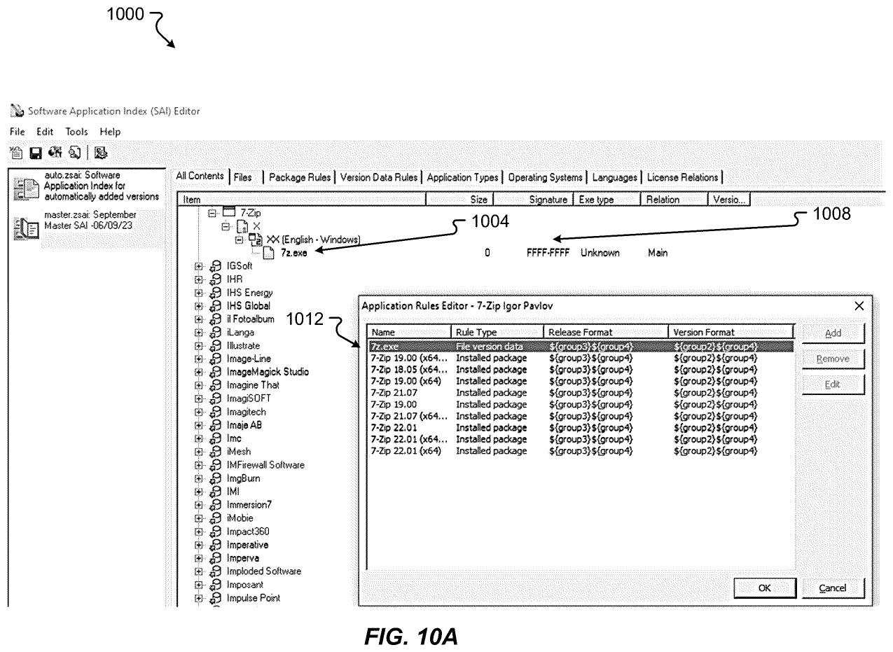

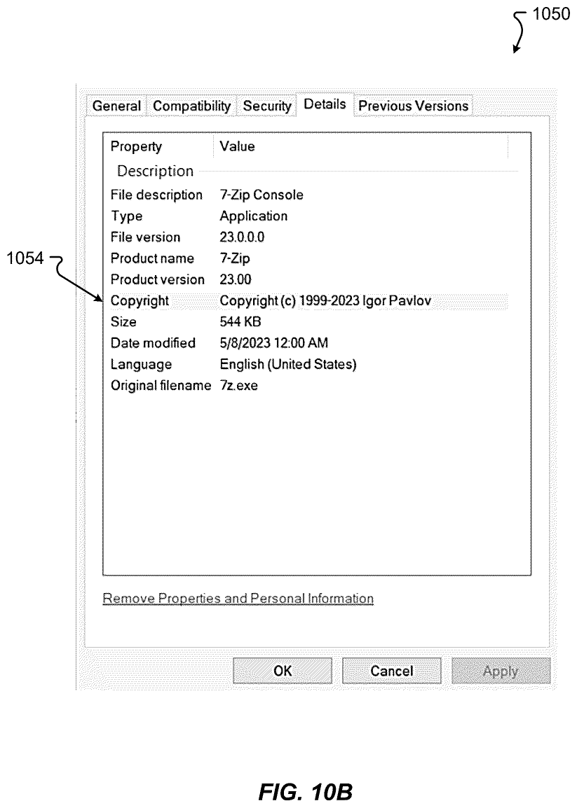

File version data rule rule-based recognition only uses the main file information to perform software application recognition. There is no need to add all of the software application information to the SAI libraries. The UD scanner collects information from files including the file name, the company name (e.g., the publisher) the file version, the product name and the product version. If there is a main file match between the information in the SAI library and the scanned information, then the main file version data will be used to as rules to help recognize the software application. FIG. 10A is a screen illustration of an exemplary user interface 1000 for identifying installed software applications using file version data rule rule-based recognition according to an embodiment of the present disclosure. As illustrated in FIG. 10A, the file name “7z.exe” 1004 is the main file. Other information such as the signature “FFFF-FFFF” 1008 is not needed. The highlighted main file entry 1012 includes the file name “7z.exe”, the rule type “File version data”, the release format “$ {group3} $ {group4}” and the version format “$ {group2} $ {group4}”. Clicking on the highlighted main file entry 1012 generates the information provided in FIG. 10B. FIG. 10B is a screen illustration of an exemplary user interface 1050 for identifying installed software applications using file version data rule-based recognition according to an embodiment of the present disclosure. As stated previously, the information for the main file 1054 includes file description “7-Zip Console”, the file type “Application”, the file version “23.0.0.0”, the product name “7-Zip”, the product version “23.00”, the size “544 KB”, etc. File version data rule rule-based recognition, however, is not suitable for all types of files. For example, file version data rule rule-based recognition is only effective for limited files such as installation files packaged with packaging tool. Java-based software applications are prevalent in the computer environment. The Java™ Archive (JAR) file format enables a programmer to bundle multiple files into a single archive file. Typically, a JAR file contains class files and auxiliary resources associated with applets and software applications. The JAR file format provides many benefits as indicated below.

Security: The contents of the JAR file can be digitally signed. Recognition of the digital signature can optionally grant the software application security privileges it wouldn't otherwise have.

Decreased download time: If an applet is bundled in a JAR file, the applet's class files, and associated resources can be downloaded to a browser in a single HTTP transaction without the need for opening a new connection for each file.

Compression: The JAR file format allows for the compression of files for efficient storage.

Packaging for extensions: The extensions framework provides a means by which add functionality can be added to the Java core platform, and the JAR file format defines the packaging for extensions. By using the JAR file format, the software application is turned into extensions as well.

Package Sealing: Packages stored in JAR files can be optionally sealed so that the package can enforce version consistency. Sealing a package within a JAR file means that all classes defined in that package must be found in the same JAR file.

Package Versioning: A JAR file can hold data about the JAR files it contains, such as vendor and version information.

Portability: The mechanism for handling JAR files is a standard part of the Java platform's core application programming interface (API).

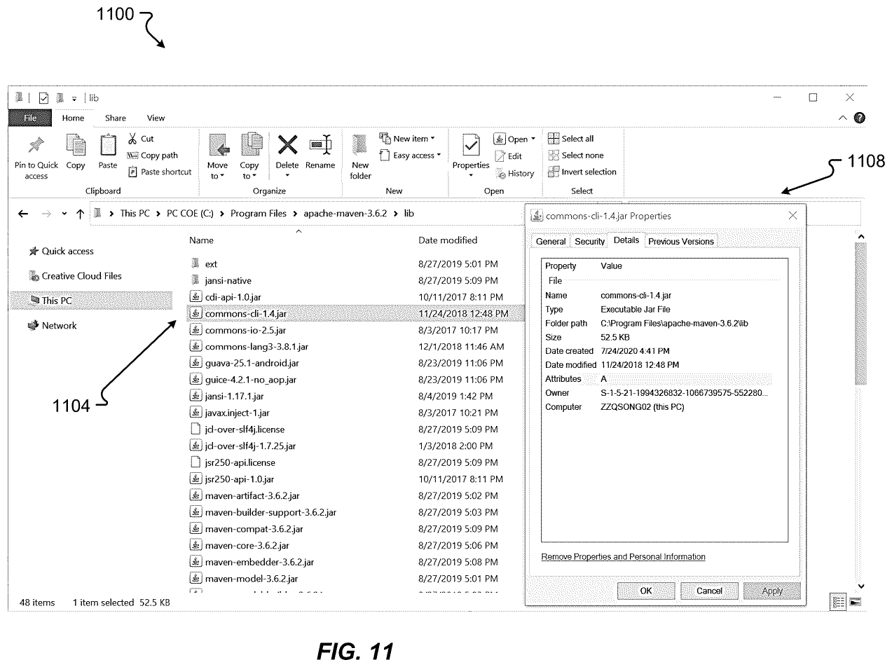

There are, however, problems associated with Java-based applications for file version data rule rule-based recognition. There is, for example, limited information in the file information to recognize the Java-based software applications. FIG. 11 is a screen illustration of an exemplary user interface 1100 for identifying installed software applications using file version data rule rule-based recognition for a Java-based software application according to an embodiment of the present disclosure. As illustrated in FIG. 11, the program files in the library for apache-maven-3.6.2 includes the program file “commons-cli-1.4.jar” 1104. There is no useful information in the file details 1108 for the program file “commons-cli-1.4.jar” 1104.

Also, JAR applications can not be recognized by name directly because of the following reasons. The name is not reliable. The JAR file name can be changed for any reason. Also, JAR files can be repackaged, so the same JAR file may have different file names, file sizes or signatures. In addition, the version information can't be discovered if the JAR file name does not include it. Moreover, multiple JAR files may be packaged into one big JAR file. If the big JAR file information is parsed, all the JAR files located in the big JAR file cannot be recognized.

According to embodiments of the present disclosure, the UD scanner is configured to also collect JAR metadata from files describing the JAV-based software application. According to one embodiment of the present disclosure, the JAR metadata is provided in a manifest file of the JAR file. According to another embodiment of the present disclosure, the JAR metadata is provided in a Project Object Model (POM) file for the JAR file. According to another embodiment of the present disclosure, the JAR metadata is provided in both the manifest file and the POM file. According to a further embodiment of the present disclosure the JAR metadata is provided in the manifest file, the POM file and/or any other files that provides attributes for JAVA-based software application as JAR metadata. The attributes may include, but are not limited to the file name, the publisher, and any other identifying information. According to further embodiments of the present disclosure, one or more files including the JAR metadata are identified. A comparison is made among the one or more files including the JAR metadata to select the file including the best attributes. The collected metadata is then reported as scan file data. The scan file data is then added to the SAI library. By adding the scan file data to the SAI library, file version data rule rule-based recognition can be used to recognize Java-based applications. According to embodiments of the present disclosure, the following benefits are provided by using file version data rule rule-based recognition to recognize Java-based applications. Emerged Vulnerability jars (Uber jar) are recognized. Java-based applications deployed in container and cloud environments are recognized more easily and efficiently. Web applications deployed in JEE servers (war files) are recognized. The recognition rate and accuracy of the application software improves significantly. The space occupied by SAI library is greatly reduced, and one rule can cover many versions. The recognition speed is greatly improved.

Jar file information can be collected in a number of different ways. On way according to embodiments of the present disclosure includes collecting Jar file information is from a text files such as for example, the manifest file from a Jave-based application. The manifest file is an integral part of the Jar file. The manifest file is typically stored within the META-INF directory of the Jar file and is named MANIFEST.MF. The manifest file contains metadata and configuration information about the JAR file. The manifest file provides the following information. Main Attributes: The manifest file includes a set of attributes that provide information about the JAR file. The most common attribute is the “Main-Class,” which specifies the entry point or main class of the software application to be executed when the JAR file is launched. Additional Attributes: The manifest file can also contain additional attributes such as “Class-Path,” which specifies the external dependencies (other JAR files) required by the software application. These attributes facilitate the class-loading process and enable the software application to locate and use the necessary resources. Versioning: The manifest file includes versioning information for the JAR file. This allows developers and users to identify the specific version of the JAR file and helps with managing dependencies and ensuring compatibility. Security Settings: The manifest file defines security-related attributes to specify the permissions required by the software application, such as access to system resources or specific APIs. This helps ensure that the software application runs with the appropriate security privileges. Custom Attributes: Developers can also add custom attributes to the manifest file to provide additional information specific to their software application or use case.

The manifest file plays an important role in Java-based applications packaged as JAR files. It provides necessary metadata and configuration details for the JAR file, enabling the Java Virtual Machine (JVM) and other tools to understand and appropriately execute the contained application. A further discussion of the systems and methods for identifying installed software applications including JAR files running on a computer system using metadata from resources on the computer system is described below.

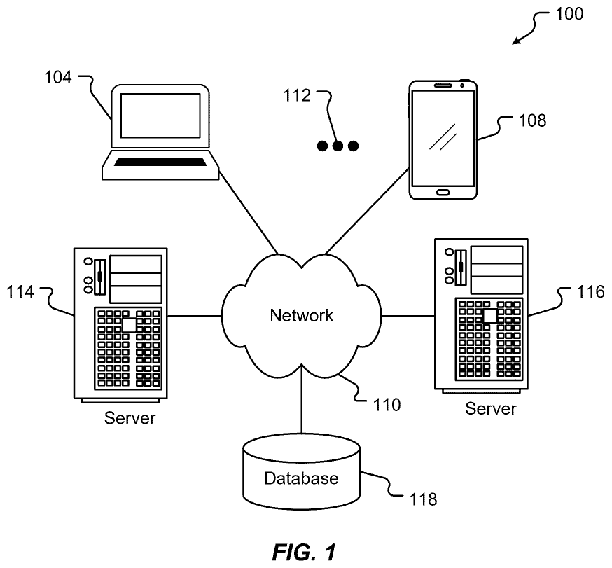

FIG. 1 is a block diagram illustrating elements of an example computing environment 100 in which embodiments of the present disclosure may be implemented. More specifically, this example illustrates a computing environment 100 that may function as the servers, user computers, or other systems provided and described herein. The environment 100 includes one or more user computers, or computing devices, such as a computer 104, a communication device 108, and/or more devices 112. The devices 104, 108, 112 may include general purpose personal computers (including, merely by way of example, personal computers, and/or laptop computers running various versions of Microsoft Corp.'s Windows® and/or Apple Corp.'s Macintosh® operating systems) and/or workstation computers running any of a variety of commercially-available UNIX® or UNIX-like operating systems. These devices 104, 108, 112 may also have any of a variety of applications, including for example, database client and/or server applications, and web browser applications. Alternatively, the devices 104, 108, 112 may be any other electronic device, such as a thin-client computer, Internet-enabled mobile telephone, and/or personal digital assistant, capable of communicating via a network 110 and/or playing audio, displaying images, etc. Although the example computer environment 100 is shown with two devices, any number of user computers or computing devices may be supported.

Environment 100 further includes a network 110. The network 110 may can be any type of network familiar to those skilled in the art that can support data communications using any of a variety of commercially-available protocols, including without limitation Session Initiation Protocol (SIP), Transmission Control Protocol/Internet Protocol (TCP/IP), Systems Network Architecture (SNA), Internetwork Packet Exchange (IPX), AppleTalk, and the like. Merely by way of example, the network 110 maybe a Local Area Network (LAN), such as an Ethernet network, a Token-Ring network and/or the like; a wide-area network; a virtual network, including without limitation a Virtual Private Network (VPN); the Internet; an intranet; an extranet; a Public Switched Telephone Network (PSTN); an infra-red network; a wireless network (e.g., a network operating under any of the IEEE 802.9 suite of protocols, the Bluetooth® protocol known in the art, and/or any other wireless protocol); and/or any combination of these and/or other networks.

The environment 100 may also include one or more servers 114, 116. For example, the servers 114, 116 may comprise build servers, which may be used to test webpage layouts on various screen sizes via the device 104, 108, 112. The servers 114, 116 can be running an operating system including any of those discussed above, as well as any commercially available server operating systems. The servers 114, 116 may also include one or more files and/or application servers, which can, in addition to an operating system, include one or more applications accessible by a client running on one or more of the devices 104, 108, 112. The server(s) 114 and/or 116 may be one or more general purpose computers capable of executing programs or scripts in response to the computers 104, 108, 112. As one example, the servers 114 and 116, may execute one or more automated tests. The automated tests may be implemented as one or more scripts or programs written in any programming language, such as Java™, C, C#®, or C++, and/or any scripting language, such as Perl, Python, or Tool Command Language (TCL), as well as combinations of any programming/scripting languages. The server(s) 114 and 116 may also include database servers, including without limitation those commercially available from Oracle®, Microsoft®, Sybase®, IBM® and the like, which can process requests from database clients running on the device 104, 108, 112.

The tests created and/or initiated by the device 104, 108, 112 (including tests created by other devices not illustrated) are shared to the server 114 and/or 116, which then may test and/or deploy the websites/webpages. The server 114 and/or 116 may transfer the generated webpage layout and/or data related to the same to the device 104, 108, 112. Although for case of description, FIG. 1 illustrates two servers 114 and 116, those skilled in the art will recognize that the functions described with respect to servers 114, 116 may be performed by a single server and/or a plurality of specialized servers, depending on implementation-specific needs and parameters. The computer systems 104, 108, 112, and servers 114, 116 may function as the system, devices, or components described herein.

The environment 100 may also include a database 118. The database 118 may reside in a variety of locations. By way of example, database 118 may reside on a storage medium local to (and/or resident in) one or more of the computers/servers 104, 108, 112, 114, 116. Alternatively, the database 118 may be remote from any or all of the computers/servers 104, 108, 112, 114, 116, and in communication (e.g., via the network 110) with one or more of these. The database 118 may reside in a Storage-Area Network (SAN) familiar to those skilled in the art. Similarly, any necessary files for performing the functions attributed to the computers/servers 104, 108, 112, 114, 116 may be stored locally on the respective computer/server and/or remotely, as appropriate. The database 118 may be used to store webpage layout data (e.g., respective locations of a plurality of elements), alerts, etc.

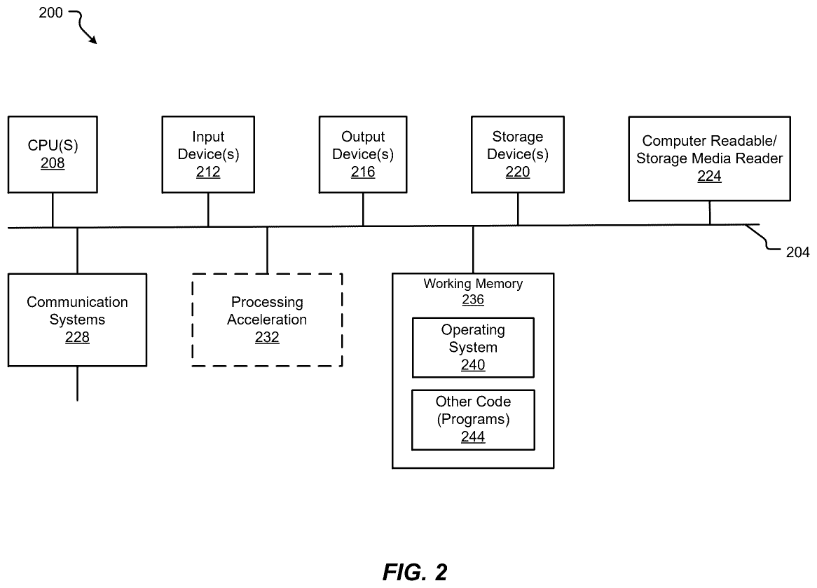

FIG. 2 is a block diagram illustrating elements of an example computing system 200 in which embodiments of the present disclosure may be implemented. More specifically, this example illustrates one embodiment of a computer system 200 upon which the servers, computing devices, or other systems or components described above may be deployed or executed. The computer system 200 is shown comprising hardware elements that may be electrically coupled via a bus 204. The hardware elements may include one or more Central Processing Units (CPUs) 208; one or more input devices 212 (e.g., a mouse, a keyboard, etc.); and one or more output devices 216 (e.g., a display device, a printer, etc.). The computer system 200 may also include one or more storage devices 220. By way of example, storage device(s) 220 may be disk drives, optical storage devices, solid-state storage devices such as a Random-Access Memory (RAM) and/or a Read-Only Memory (ROM), which can be programmable, flash-updateable and/or the like.

The computer system 200 may additionally include a computer-readable storage media reader 224; a communications system 228 (e.g., a modem, a network card (wireless or wired), an infra-red communication device, etc.); and working memory 236, which may include RAM and ROM devices as described above. The computer system 200 may also include a processing acceleration unit 232, which can include a Digital Signal Processor (DSP), a special-purpose processor, and/or the like.

The computer-readable storage media reader 224 can further be connected to a computer-readable storage medium, together (and, optionally, in combination with storage device(s) 220) comprehensively representing remote, local, fixed, and/or removable storage devices plus storage media for temporarily and/or more permanently containing computer-readable information. The communications system 228 may permit data to be exchanged with a network and/or any other computer described above with respect to the computer environments described herein. Moreover, as disclosed herein, the term “storage medium” may represent one or more devices for storing data, including ROM, RAM, magnetic RAM, core memory, magnetic disk storage mediums, optical storage mediums, flash memory devices and/or other machine-readable mediums for storing information.

The computer system 200 may also comprise software elements, shown as being currently located within a working memory 236, including an operating system 240 and/or other code 244. It should be appreciated that alternate embodiments of a computer system 200 may have numerous variations from that described above. For example, customized hardware might also be used and/or particular elements might be implemented in hardware, software (including portable software, such as applets), or both. Further, connection to other computers such as network input/output devices may be employed.

Examples of the processors 208 as described herein may include, but are not limited to, at least one of Qualcomm® Snapdragon® 800 and 801, Qualcomm® Snapdragon® 620 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

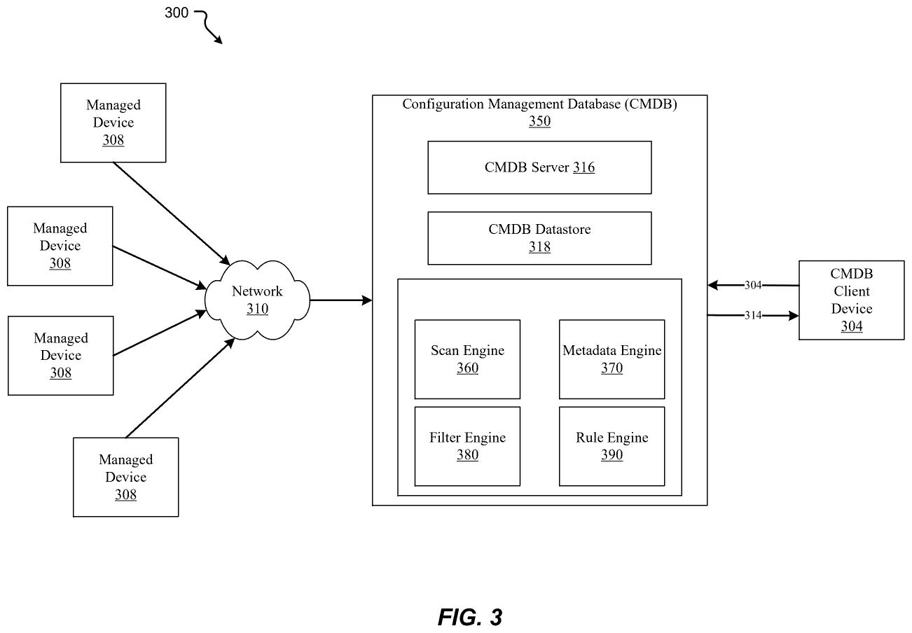

FIG. 3 is a block diagram illustrating elements of an example computing environment 300 for identifying installed software applications running on managed devices using metadata from resources on the managed devices in which embodiments of the present disclosure may be implemented. Computing environment 300 generally includes one or more managed device 308, a network 310 a configuration management database CMDB 350 and a CMDB client 304. The computing environment manages CIs of the managed devices 308. The managed device 308 can be similar to one more of the user computers, or computing devices, such as a computer 104, communication device 108, and/or more devices 112 or one or more servers 114, 116 illustrated in FIG. 1. The network 310 can be any type of network familiar to those skilled in the art that can support data communications using any of a variety of commercially-available protocols. CMDB client 304 may be the same as a computer 104, communication device 108, and/or more devices 112 illustrated in FIG. 1.

CMDB 350 includes a CMDB server 316, a CMDB datastore 318 and at least a scan engine 360, a metadata engine 370, a filter engine 380, and a rule engine 390. The CMDB 350 may potentially be populated with CIs by various processes from the managed devices 308. The CMDB client 304 having an CMDB client application running thereon is capable of defining and executing a request 304 to start a discovery process for one or more of the managed devices 308. The CMDB client 304 receives the results 314 of the discovery process. The CMDB client 304 may include, for example, a user interface where the discovery properties are defined, and parameters of the discovery process are specified.

A CI may span one or many CI records stored in the CMDB datastore 318 in one or many tables in the CMDB datastore 318, with each CI record having references to the other CI records that make up the CI. For example, at least a portion of a CI record stored in the CMDB datastore 318 may refer to a sub-component of a server, such as a network interface card or various software applications present on the server. Additional information about the CI may also exist outside of CMDB datastore 318.

The discovery properties may include, for example, configuring a Universal Discovery (UD) scanner to collect metadata from text files associated with a software application (e.g., resources) and report this information a scan file data. The metadata may include attributes such as, for example, file name, vendor, version, etc. According to one embodiment of the present disclosure, these attributes are assigned a weighted value based on importance in identifying a software application. For example, the attribute “file name” may be assigned a weighted value of “0.5” while the attribute “vender” may be assigned a weighted vale “0.3”.

According to an embodiment of the present disclosure, the UD scanner discovers one or more candidate text files that include one or more of the attributes defined by the metadata. The candidate text files are further examined to discover how many of the attributes are found within a candidate text file. According to further embodiment of the present disclosure, the candidate text files are further examined to discover the candidate text file with the highest accumulated weighted value.

Some text files associated with a software application have more metadata provided therein than others. One such text file is the manifest file of a JAR file as discussed in greater detail below. Another text file that has a more metadata than other files includes the POM.xml file.

The scan engine 360 is configured to operate the UD scanner to identify CIs. The metadata engine is configured to operate the UD scanner to also identify the metadata. The filter engine 380 is configured to operate a processor in CMDB server 316 to filter and select a candidate text file to extract the metadata to identify the software application. According to a further embodiment of the present disclosure, one or more candidate text files are selected to identify the software application.

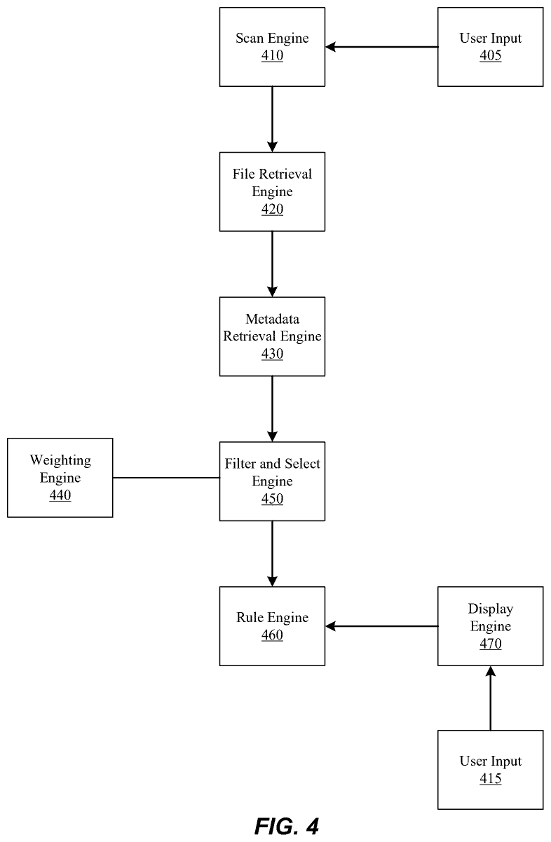

FIG. 4 is a block diagram illustrating an example software recognition system 400 in which embodiments of the present disclosure may be implemented. The software recognition system 400 generally includes a scan engine 410, a file retrieval engine 420, a metadata retrieval engine 430, a filter and select engine 450, a rule engine 460 and a display engine 470. The scan engine 410 is configured to identify files including text files using the UD scanner. According to one embodiment of the present disclosure, the discovered files are passed to the file retrieval engine and the text files are passed to the metadata retrieval engine 430.

According to one embodiment of the present disclosure, the weighting engine 440 is configured to assign a weight value to the attributes defined by the metadata. After weight values are assigned to the attributes, the filter and select engine 450 is configured to filter candidate text files that have the attributes to determine one or more candidate text files for selection. For example, the manifest.mf file may be selected as the best candidate text files based on a score generated from the weighted attributes in the text files. According to an alternative embodiment of the present disclosure, the POM.xml file may be selected as the best candidate text file based on a score generated from the weighted attributes in the text files. According to a further embodiment of the present disclosure, both the manifest.mf text file and the POM.xml text file are selected as the best candidate text files based on a score generated from the weighted attributes contained in the text files. According to a further embodiment of the present disclosure, one or more candidate text files are presented to a user, or an administrator and the user or administrator is given the opportunity to select the one more candidate text files with the highest weighted score for the attributes. The user or administrator can select one or more candidate text files that does not have the highest weighted score for the attributes but select another candidate text file with a lower weighted score for the attributes.

After one or more candidate text files have been selected, the rule engine 460 is configured to establish a rule to identify software applications. After a rule has been established by the rule engine 460, the display engine 470 is configured generate topology for displaying a managed node along with the identified software application. According to one embodiment of the present disclosure, user input 415 is used to request display of the topology as well as request other CIs related to the node that for display as well as filter related CIs by CI type.

According to embodiments of the present disclosure, UD scanners are improved to scan the entire disk or specific location to read the metadata from manifest.mf files.

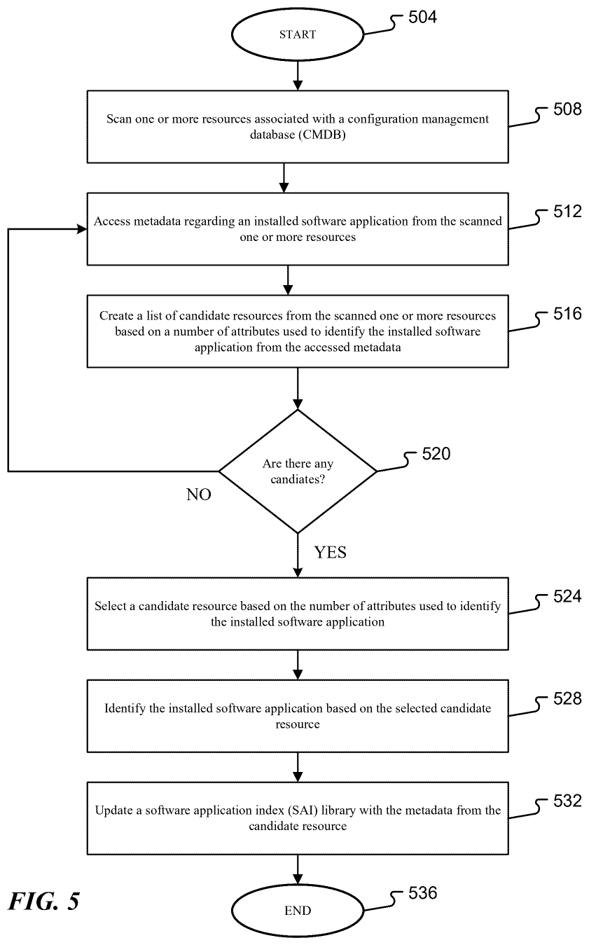

FIG. 5 is a flowchart illustrating an example method 500 for identifying installed software applications running on a computer system using metadata from resources on the computer system according to an embodiment of the present disclosure. While a general order of the steps of method 500 is shown in FIG. 5, method 500 can include more or fewer steps or can arrange the order of the step differently than those shown in FIG. 5. Further, two or more steps may be combined in one step. Generally, method 500 starts with a START operation at step 504 and ends with an END operation at step 536. The method 500 can be executed as a set of computer-executable instructions executed by a computer system (e.g., processor 208, the CMDB server, etc.) and encoded or stored on a computer readable medium. Hereinafter, method 500 shall be explained with reference to the systems, components, modules, applications, software, data structures, user interfaces, etc. described in conjunction with FIGS. 1-4 and 6-22.

Method 500 begins with the START operation at step 504 and proceeds to step 508, where the processor 208 and/or the scan engine 360 scans one or more resources associated with a configuration management database (CMDB). After the processor 208 and/or the scan engine scans one or more resources associated with CMDB at step 508, method 500 proceeds to step 512, where the processor 208 and/or the metadata engine 370 accesses metadata regarding an installed software application from the scanned one or more resources. After the processor 208 and/or the metadata engine 370 accesses metadata regarding an installed software application from the scanned one or more resources at step 512, method 500 proceeds to step 516, where the processor 208 and/or the metadata engine 370 creates a list of candidate resources from the scanned one or more resources based on a number of attributes used to identify the installed software application from the accessed metadata. After the processor and/or the metadata engine 370 creates a list of candidate resources from the scanned one or more resources based on a number of attributes used to identify the installed software application from the accessed metadata at step 516, method 500 proceeds to decision step 520 where the processor 208 and/or the metadata engine determines if there is at least one candidate resource. If there are no candidate resources (NO) at decision step 520, method 500 returns to step 512, where the processor 208 and/or the metadata engine 370 creates a list of candidate resources from the scanned one or more resources based on a number of attributes used to identify the installed software application from the accessed metadata.

If there are candidate resources (YES) at decision step 520, method 500 proceeds to step 524, where the processor 208 and/or the metadata engine 370 selects a candidate resource based on the number of attributes used to identify the installed software application. After the processor 208 and/or the metadata engine 370 selects a candidate resource based on the number of attributes used to identify the installed software application at step 524, method 500 proceeds to step 528, where the processor 208 identifies the installed software application based on the selected candidate resource. After the processor 208 identifies the installed software application based on the selected candidate resource at step 528, method 500 proceeds to step 532, where the processor 208 updates the software application index (SAI) library with the metadata from the candidate resource. After the processor 208 updates the software application index (SAI) library with the metadata from the candidate resource at step 532, method 500 ends with the END operation at step 528.

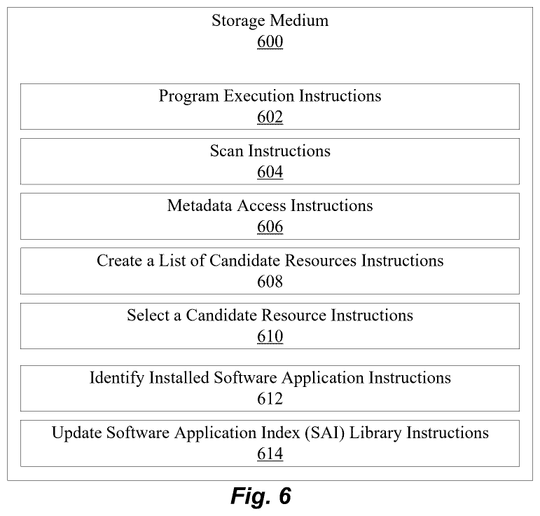

FIG. 6 is a block diagram of a non-transitory machine-readable or computer-readable storage medium 600 storing machine-readable instructions that upon execution cause a system to perform various tasks. The machine-readable instructions include program execution instructions 602 to execute an application that generates a GUI screen.

The machine-readable instructions include scan instructions 604 used to scan files of a database. The machine-readable instructions further include metadata access instructions 606 used to obtain metadata. The machine-readable instructions include create a list of candidate resources instructions 608 used to determine, based on the obtained metadata, a list of files that contain the metadata. The machine-readable instructions further include select a candidate resource instructions 610 used to identify a candidate that includes the most metadata. The machine-readable instructions further include identify installed software application instructions 612 and update software application index (SAI) library instructions 614.

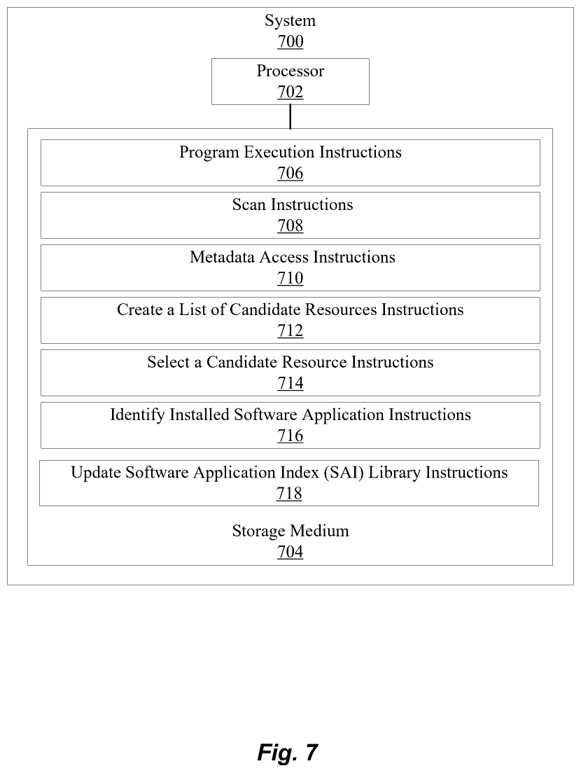

FIG. 7 is a block diagram of a system 700 according to some examples. The system 700 includes a hardware processor 702 (or multiple hardware processors). A hardware processor can include a microprocessor, a core of a multi-core microprocessor, a microcontroller, a programmable integrated circuit, a programmable gate array, a digital signal processor, or another hardware processing circuit.

The system 700 further includes a storage medium 704 storing machine-readable instructions executable on the hardware processor 702 to perform various tasks. Machine-readable instructions executable on a hardware processor can refer to the instructions executable on a single hardware processor or the instructions executable on multiple hardware processors.

The machine-readable instructions stored in the storage medium 704 include program execution instructions 706 to execute an application that generates a GUI screen. The machine-readable instructions further include instructions 708 to scan files in a database. The machine-readable instructions further include metadata access instructions 710 to find metadata associated with a software application.

The machine-readable instructions include create a list of candidate resources instructions 712, a select a candidate resource instructions 714, an identify installed software application instructions 716 and an update software application index (SAI) library instructions.

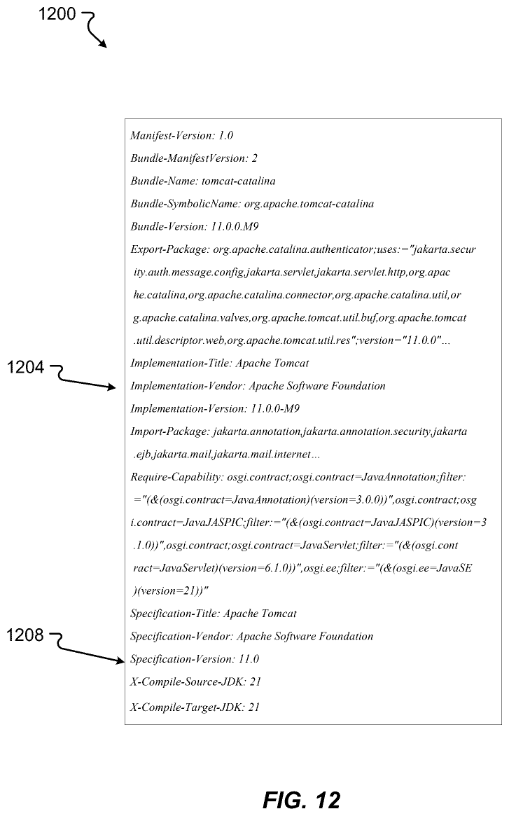

According to embodiments of the present disclosure a further discussion of the manifest file is provided. FIG. 12 is list of attributes 1200 provided in the resource describing an installed software application according to an embodiment of the present disclosure. According to an embodiment of the present disclosure, the list of attributes 1200 represents the MANIFEST.MF file for the main file “catalina.jar” as discussed above with reference to FIG. 8. Of the list of attributes 1200 provided in FIG. 12, two attributes “Implementation Vendor” 1204 and “Specification Version” 1208 are further discussed. Starting with “Specification Version” 1208, this attribute is a string value that defines the version of the extension specification. Turing to “Implementation Vendor” 1204, this attribute is a string value the defines the organization that maintains the extensions implementation.

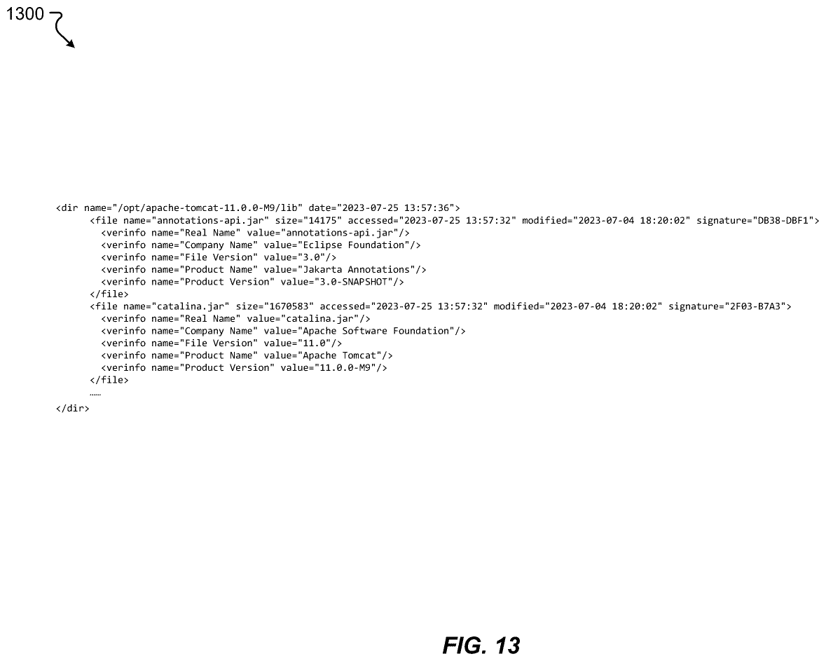

FIG. 13 is an example scan file 1300 that contains collect JAR file information according to an embodiment of the present disclosure. According to an embodiment of the present disclosure, the UD scanner is programmed to collection additional information such as the directory path, file information (e.g., the name of the file, the size of the file, the company/organization name, the product name, the product version, etc.), map to some file attributes (what are the file attributes) and save the scan file 1300. When mapping the file attributes to the metadata in the manifest/mf file, the following rules are identified as illustrated in TABLE 1.

TABLE 1

| File attribute in scan file | Metadata in MANIFEST.MF |
|---|---|
| Real Name | just JAR file name |
| Company Name | Implementation-Vendor |
| File Version | Specification-Version |
| Product Name | Implementation-Title > |
| | Bundle-Name/Application-Name/Name/ |
| | Specification-Title |
| Product Version | Implementation-Version > |
| | Bundle-Version |
| File Description | Main-Class > |
| | Class-Path/Bundle-Description |

The POM.xml file is an important configuration file used in Maven-based projects. Maven is a build automation and dependency management tool commonly used in Java development. While the POM.xml file is not specifically for JAR files, it is used to define the project's settings, dependencies, build process, and other project-related information, including the creation of JAR files. Here are some key aspects of the POM.xml file related to JAR file creation: Project Information: The POM.xml file includes project-specific information such as the project's name, version, description, and the organization or developer details. Dependencies: The POM.xml file lists the dependencies required by the project. These dependencies can include other JAR files or libraries that the project relies on. Maven automatically resolves and manages these dependencies during the build process. Build Configuration: The POM.xml file specifies the build configuration for the project, including the build plugins, goals, and phases. The build process defined in the pom.xml file can include the creation of JAR files, compilation of source code, running tests, packaging resources, and more. Packaging Type: The POM.xml file specifies the packaging type for the project. For JAR file creation, the packaging type is set as “jar” in the pom.xml file. Maven uses this information to generate the JAR file during the build process. Build Output: The POM.xml file defines the output location for the built artifacts, including the JAR file. By default, Maven generates the JAR file in the target directory of the project. Plugins and Customization: The POM.xml file allows for the configuration of various plugins that can customize the build process. Plugins specific to JAR file creation, such as the Maven JAR Plugin, can be configured in the POM.xml file to control aspects such as the JAR file's manifest, inclusion/exclusion of files, and more. Overall, the POM.xml file serves as a central configuration file for Maven projects, including those that involve the creation of JAR files. It provides a standardized and declarative approach to managing project dependencies, build processes, and other project-related settings. Sometimes, one JAR file is packaged by many components, and assembled by maven, so from POM.xml, we can find some clues to see all dependencies. According to embodiment of the present disclosure, the POM file or the Manifest file is selected.

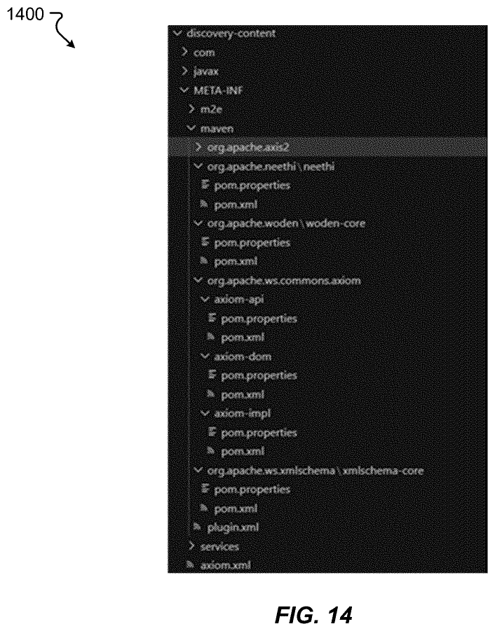

FIG. 14 is an example POM file 1400 according to an embodiment of the present disclosure.

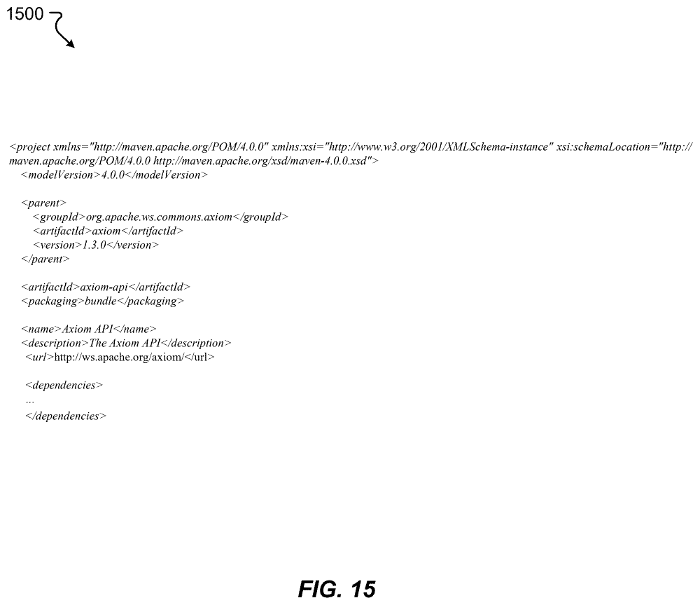

The UD scanner opens the JAR file and goes through each of the POM.xml files. The Pom.xml file is parsed, and sub-component information is extracted. The sub-components from the sub-component information is reported separately because they are standing for different JARs. FIG. 15 is an example POM.xml file 1500 according to an embodiment of the present disclosure. In FIG. 15 the POM.xml file 1500 is an example for “axiom-api”.

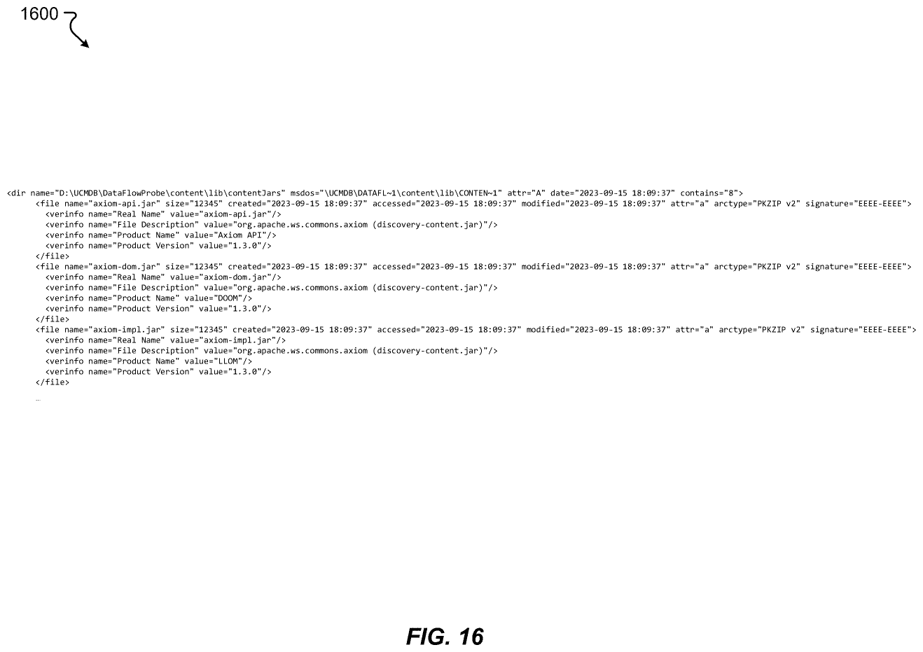

FIG. 16 is an example scan file 1600 that contains collect JAR file information according to an embodiment of the present disclosure. According to an embodiment of the present disclosure, after the UD scanner collects the sub-component information, the UD scanner stores the sub-component information as JAR files in the scan file 1600 illustrated in FIG. 16.

When mapping the file attributes to the metadata in the POM.xml file, the following rules are identified as illustrated in Table 2.

TABLE 2

| File attribute in scan file | Metadata in Pom.xml |
|---|---|
| Real Name | sub-component name as JAR name |
| Product Name | name > artifact-id > group-id |
| Product Version | version |
| File Description | group-id + (container-jar) |

After parsing the POM.xml file, a big JAR file can be divided into several smaller component JAR files. Each smaller component JAR file can deliver value to users after recognition.

According to embodiment of the present disclosure, a JAR version data rule rule-based recognition is established. The JAR version data rule-based recognition supplements the file version data rule rule-based recognition. According to embodiments of the present disclosure, SAI libraries are improved to recognize JAR libraries and/or software applications from JAR metadata. After acquiring the file version data from the JAR files (as discussed above in FIG. 11), the file version data rules in the SAI library are added and JAR recognition or JAVA-based application recognition can be performed.

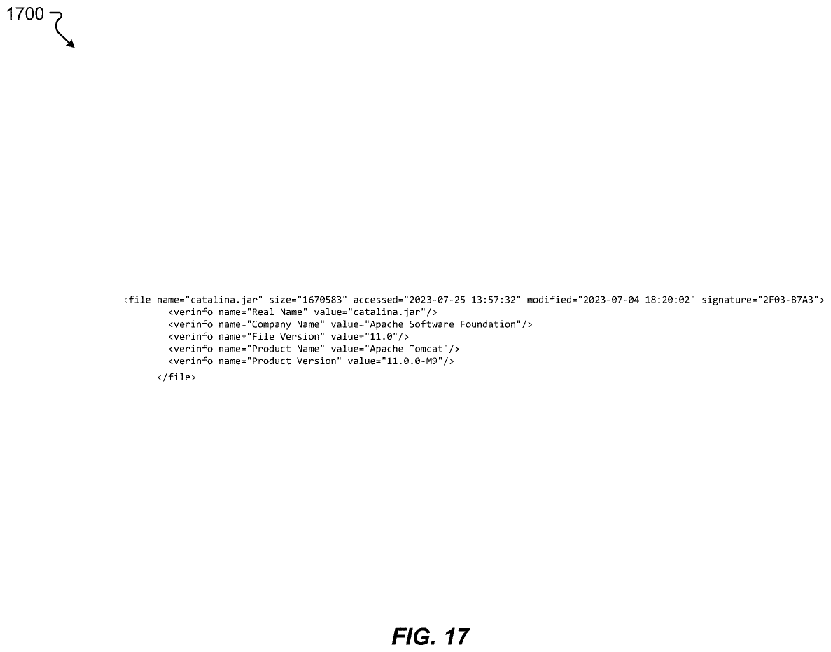

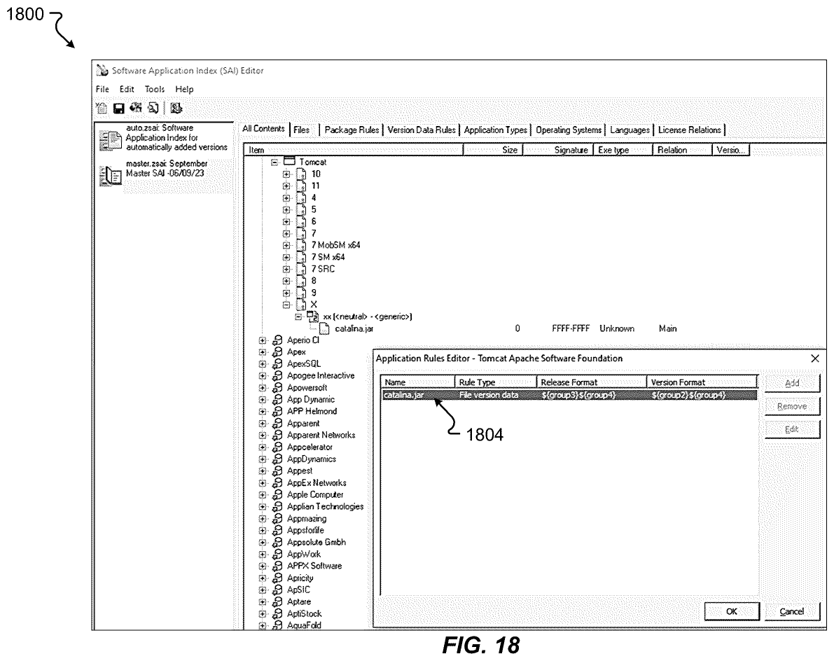

FIG. 17 is an example scan file 1700 according to an embodiment of the present disclosure. As illustrated in FIG. 17, “catalina.jar” is discovered in the scan file and the information is shown in FIG. 17. The file “catalina.jar” has been established as the “MAIN” file for the application “tomcat” as discussed above in FIG. 8. As illustrated in FIG. 17, the file “catalina.jar” is version 11, while the file “catalina.jar” illustrated in FIG. 8 is version 10. Therefore, this new version (version 11) of the application “tomcat” is not recognized in the SAI library. With the file version data collected in the scan file as illustrated in FIG. 17, a rule is added in the SAI library as illustrated in FIG. 18. FIG. 18 is an example screen illustration 1800 of an exemplary user interface for a rule added to software application index (SAI) libraries according to an embodiment of the present disclosure. This rule means that once the existence of this JAR file (“catalina.jar”) is detected, it can be concluded that the “tomcat” application must be installed on the node, and the version and publisher information can be obtained directly from the file version data and reported. For example, there is a file version data rule made for the catalina.jar file. In this rule, a regular expression of ((([0-9]+)[0-9.]*)([\64 bit\)]*)) is provided (see FIG. 9A, element 904) for product version. The highlighted entry 1804 includes the release format “S {group3} $ {group4}” and the version format “$ {group2} $ {group4}” as illustrated in FIG. 10A. Finally, “tomcat” will be reported as a software application.

There are additional cases to use this method to recognize Java-based applications. By recognizing JAR files and versions, it is much easier to do vulnerabilities detection, like log 4j. The CVE-2021-44228 RCE vulnerability-affecting Apache's Log 4j library, versions 2.0-beta9 to 2.14.1-exists in the action the Java Naming and Directory Interface (JNDI) takes to resolve variables. According to the CVE-2021-44228 listing, affected versions of Log 4j contain JNDI features-such as message lookup substitution—that “do not protect against adversary-controlled LDAP [Lightweight Directory Access Protocol] and other JNDI related endpoints.” Also, it is much faster to discover java-based applications. We can know the topology quickly and know much better inside a big JAR file, even for JAR dependencies. For example, there is an older version of tomcat installed on the computer, and with current solutions, we can recognize this tomcat and its version, also we found it is using a log 4j jar file which contains vulnerabilities. With this case, customers can have a clear picture of what they are using, and they can decide how to deal with it.

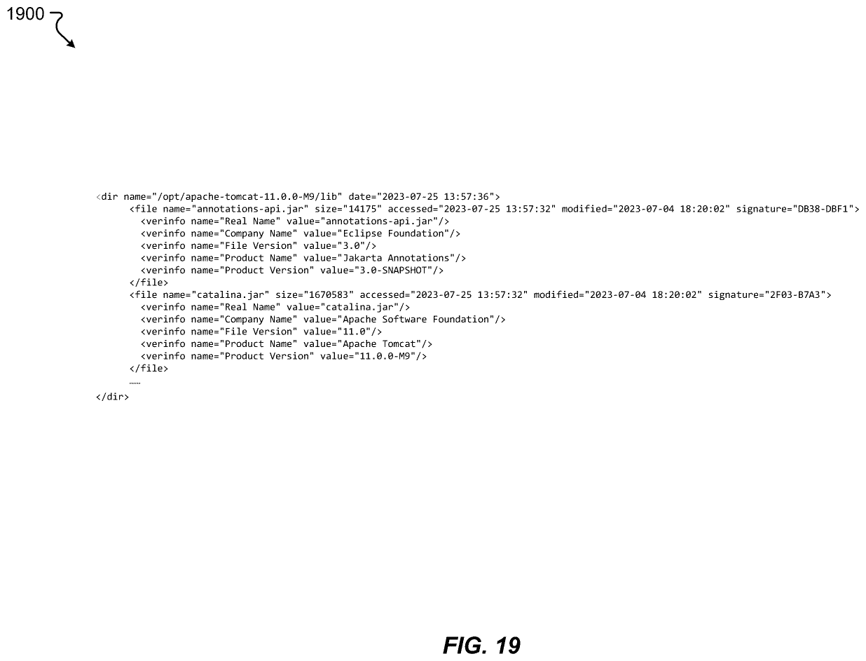

FIG. 19 is an example scan file 1900 which collects JAR information according to an embodiment of the present disclosure. According to embodiments of the present disclosure, the scan file 1900 represents the “tomcat” CI reported to the CMDB.

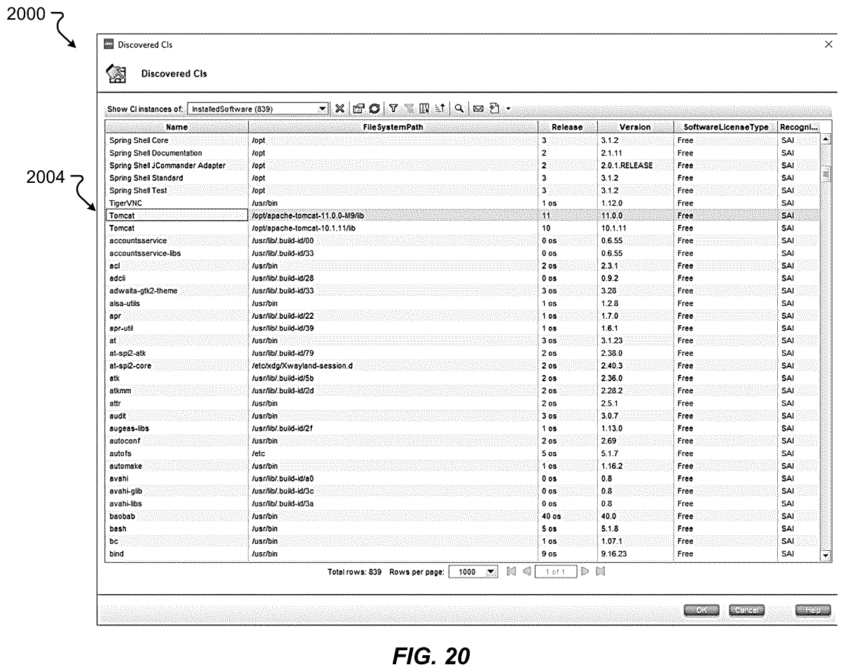

FIG. 20 is an example screen illustration 2000 of an exemplary user interface for an application CI for a node to be reported to a CMDB according to an embodiment of the present disclosure. As illustrated in FIG. 20, the “tomcat” CI is highlighted at 2004. Moreover, there are 839 Installed Software CIs reported on this Node (PC/Server). Also, the user interface provides for the user to obtain the topology for a node and the software applications provided at the node.

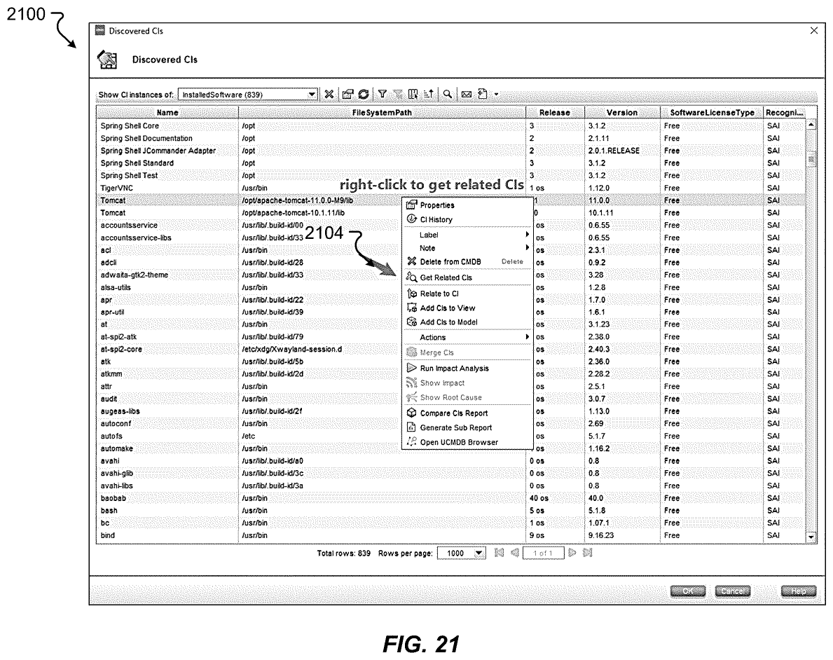

FIG. 21 is an example screen illustration 2100 of an exemplary user interface for an application CI for a node to be reported to a CMDB according to an embodiment of the present disclosure. As illustrated in FIG. 21, a drop-down box 2104 is provided for the “tomcat” CI such that related CIs can be displayed.

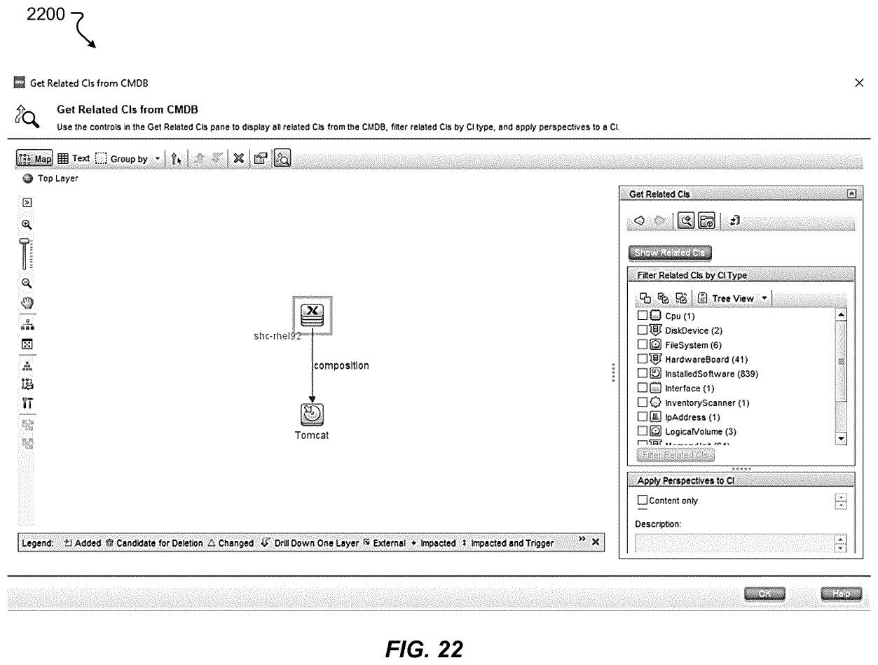

FIG. 22 is an example screen illustration 2220 of an exemplary user interface for a topology of an installed software application and the node on which the software application is installed along with related CIs according to embodiments of the present disclosure. Here the Node (shc-rhel92) installed “tomcat”. By examining the properties of the “tomcat” CI, the software application “tomcat” is installed in “/opt/apache-tomcat-11.0.0-M9/lib” and the version is “11.0.0”.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

Any of the steps, functions, and operations discussed herein can be performed continuously and automatically.

However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should however be appreciated that the present disclosure may be practiced in a variety of ways beyond the specific details set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosure.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving case and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A system, comprising:
at least one processor; and
a computer readable medium, coupled with the at least one processor and comprising processor readable and executable instructions that, when executed by the at least one processor, cause the at least one processor to:
scan one or more resources associated with a configuration management database (CMDB);
access metadata regarding an installed software application from the scanned one or more resources;
create a list of candidate resources from the scanned one or more resources based on a number of attributes used to identify the installed software application from the accessed metadata;
select a candidate resource based on the number of attributes used to identify the installed software application;
identify the installed software application based on the selected candidate resource; and
update a Software Application Index (SAI) library with the metadata from the candidate resource.

2. The system according to claim 1, wherein the installed software application is a software application developed using Java programming language and runs on a Java Virtual Machine (JVM).

3. The system according to claim 1, wherein one of the one or more resources includes a manifest file for the installed software application.

4. The system according to claim 3, wherein the manifest file includes at least one of a real number, a company name, a file version, a product name, a product version, and a file description for the installed software application.

5. The system according to claim 1, wherein one of the one or more resources includes a Project Object Model (POM) file associated with the installed software application.

6. The system according to claim 5, wherein the POM file includes at least one of a real name, a product name, a product version, and a file description associated with the installed software application.

7. The system according to claim 1, wherein metadata associated with a product version attribute is used to update the SAI library.

8. The system according to claim 7, wherein the at least one processor is further caused to implement a file version data rule associated with the product version attribute for detecting other installed software applications.

9. The system according to claim 8, wherein a size of the SAI library is reduced based on the implemented file version data rule.

10. The system according to claim 1, wherein the at least one processor is further caused to generate, for display, a graphical relationship between the installed software application and a node on which the installed software application is provided.

11. A method, comprising:
scanning, by universal discovery scanner, one or more resources associated with a configuration management database (CMDB);
accessing, the universal discovery scanner, metadata regarding an installed software application from the scanned one or more resources;
creating, by one or more processors, a list of candidate resources from the scanned one or more resources based on a number of attributes used to identify the installed software application from the accessed metadata;
selecting, by the one or more processors, a candidate resource based on the number of attributes used to identify the installed software application;
identifying, by the one or more processors, the installed software application based on the selected candidate resource; and
updating, by the one or more processors, a Software Application Index (SAI) library with the metadata from the candidate resource.

12. The method according to claim 11, wherein the installed software application is a software application developed using Java programming language and runs on a Java Virtual Machine (JVM).

13. The method according to claim 11, wherein one of the one or more resources includes a manifest file for the installed software application.

14. The method according to claim 13, wherein the manifest file includes at least one of a real number, a company name, a file version, a product name, a product version, and a file description for the installed software application.

15. The method according to claim 11, wherein one of the one or more resources includes a Project Object Model (POM) file associated with the installed software application.

16. The method according to claim 15, wherein the POM file includes at least one of a real name, a product name, a product version, and a file description associated with the installed software application.

17. The method according to claim 11, wherein metadata associated with a product version attribute is used to update the SAI library.

18. The method according to claim 17, further comprising implementing, by the one or more processors, a file version data rule associated with the product version attribute for detecting other installed software applications.

19. The method according to claim 18, wherein a size of the SAI library is reduced based on the implemented file version data rule.

20. A non-transitory computer readable medium having stored thereon instructions that causes one or more processors to execute a method, the method comprising:
scanning one or more resources associated with a configuration management database (CMDB);
accessing metadata regarding an installed software application from the scanned one or more resources;
creating a list of candidate resources from the scanned one or more resources based on a number of attributes used to identify the installed software application from the accessed metadata;
selecting a candidate resource based on the number of attributes used to identify the installed software application;
identifying the installed software application based on the selected candidate resource; and
updating a Software Application Index (SAI) library with the metadata from the candidate resource.
